(19) United States
(12) Patent Application Publication
(10) Pub. No.: US 2015/0263495 A1
(43) Pub. Date: Sep. 17, 2015

(54) GROMMETS AND WIRE HARNESSES

(71) Applicant: SUMITOMO WIRING SYSTEMS, LTD., Mie (JP)

(72) Inventor: Ryo SUENAGA, Mie (JP)

(73) Assignee: SUMITOMO WIRING SYSTEMS, LTD., Mie (JP)

(21) Appl. No.: 14/633,720

(22) Filed: Feb. 27, 2015

(30) Foreign Application Priority Data
Mar. 12, 2014 (JP) 2014-048397

(51) Int. Cl. H02G 3/04; H01B 7/17

(52) U.S. Cl. CPC H02G 3/0406; H01B 7/17

(57) ABSTRACT

A wire-harness grommet that is not easily dislodged from a plate while minimizing the increase in its weight and cost is provided. In a grommet, a small-diameter cylindrical portion is connected to a connecting portion and can be bound at its ends to a member penetrating an interior of the small-diameter cylindrical portion. A large-diameter cylindrical portion includes an oblique reduced-diameter portion extending fully circumferentially and obliquely inward from where it is connected to the connecting portion. The small-diameter cylindrical portion includes a deformation limiting portion that protrudes farther than other parts of the small-diameter cylindrical portion so as to oppose the oblique reduced-diameter portion. The deformation limiting portion limits the range of inward deformation of the oblique reduced-diameter portion.

### TECHNICAL FIELD

The present invention relates to a grommet for protecting a linear member, such as electric wires, passed through a hole in a plate.

### BACKGROUND ART

Conventionally, grommets for protecting bundles of electric wires, passed through holes in plates, such as resin plates or metal plates, are used with wire harnesses mounted in vehicles, such as automobiles. Generally, grommets are elastic members made of rubber or elastomer. Some grommets have a structure that combines such an elastic member and a resin member or a metal member.

A grommet may include a large-diameter cylindrical portion with an annular recess formed therein into which the rim of a hole in a plate is fitted and a small-diameter cylindrical portion that is bound to the linear member passed therethrough. The grommet may further include a connecting portion that connects the large-diameter cylindrical portion and the small-diameter cylindrical portion around its entire circumference. The plate in which the hole is formed also may serve as a support plate for supporting the grommet.

As for a wire harness for a vehicle, it is important that the large-diameter cylindrical portion of a grommet can be easily fitted in a hole in a plate and that the grommet is not easily dislodged from the plate. For example, the connecting portion of the grommet may be formed to be relatively thin, such that the small-diameter cylindrical portion is easily displaced in the large-diameter cylindrical portion. As a result, even if the linear member passed through the small-diameter cylindrical portion is bent in close proximity to the grommet, the large-diameter cylindrical portion is not easily dislodged from the plate.

In the grommets of JP 2011-217552A and JP2012-100396A, the reduced diameter part of the outer peripheral cylindrical portion (part of the large-diameter cylindrical portion) is formed by extending fully circumferentially and obliquely inward from where it is connected to the connecting portion (the radially extending portion). This makes it easy to fit the large-diameter cylindrical portion of the grommet in the hole in the plate.

Moreover, as shown in FIG. 3 of JP 2011-217552A, when the wire harness (a bundle of electric wires) is pulled, the large-diameter cylindrical portion is deformed inward by the pulling force from the small-diameter cylindrical portion and the connecting portion (a radially extending portion). In this case, the part of the outer peripheral cylindrical portion (the large-diameter cylindrical portion) that extends obliquely inward is brought into contact with the small-diameter cylindrical portion. This limits the range of inward deformation of the outer peripheral cylindrical portion, thus making it difficult for the grommet to be dislodged from the plate.

JP 2011-217552A and JP2012-100396A are examples of related art.

### SUMMARY OF THE INVENTION

In some grommets, the difference is large between the diameter of the outer rim of the large-diameter cylindrical portion, which corresponds to the hole in the plate, and the diameter of the inner rim of the small-diameter cylindrical portion, which corresponds to the linear member. This difference between the diameters will be referred to as the inner-outer diametrical difference hereinafter.

In the grommets of JP 2011-217552A and JP2012-100396A, in order to ensure that the grommet is not easily dislodged from the plate due to the pulling force from the small-diameter cylindrical portion and the connecting portion, the larger the inner-outer diametrical difference is, the longer and thicker the part of the large-diameter cylindrical portion that extends obliquely inward needs to be. That, however, will increase the weight and cost of the grommet.

In the meantime, it is desired to reduce the weights and costs of grommets for automotive wire harnesses.

The object of the present invention is to provide a wire-harness grommet that is not easily dislodged from a plate while minimizing increase in its weight and cost.

In one aspect, a grommet comprises an elastic member provided with a large-diameter cylindrical portion, a connecting portion, and a small-diameter cylindrical portion. The aforementioned large-diameter cylindrical portion is a cylindrical portion having an annular recess formed therein into which a rim of a hole in a plate can be fitted. The aforementioned connecting portion is a portion that extends fully circumferentially and further inward from an inner surface of the large-diameter cylindrical portion. The small-diameter cylindrical portion is a portion connected to the connecting portion and can be bound at its ends to a member penetrating an interior of the small-diameter cylindrical portion. The large-diameter cylindrical portion includes an oblique reduced-diameter portion extending fully circumferentially and obliquely inward from where the large-diameter cylindrical portion is connected to the connecting portion. The small-diameter cylindrical portion includes a deformation limiting portion that protrudes farther than other parts of the small-diameter cylindrical portion so as to oppose the oblique reduced-diameter portion. The aforementioned deformation limiting portion limits the range of inward deformation of the oblique reduced-diameter portion.

A second aspect is an example of the first aspect. In the grommet of the second aspect, the small-diameter cylindrical portion has a plurality of the deformation limiting portions formed side by side at intervals around the periphery of the small-diameter cylindrical portion.

A third aspect is an example of the first or second aspect. In the grommet according to the third aspect, the small-diameter cylindrical portion comprises an inner small-diameter cylindrical portion and an outer small-diameter cylindrical portion. The aforementioned inner small-diameter cylindrical portion is a cylindrical portion connected to an innermost part of the connecting portion. The aforementioned outer small-diameter cylindrical portion is a portion formed outside of the inner small-diameter cylindrical portion so as to be connected to a part of the connecting portion closer to the large-diameter cylindrical portion than the part of the connecting portion connected to the inner small-diameter cylindrical portion. The deformation limiting portion(s) is formed on the aforementioned outer small-diameter cylindrical portion.

In a forth aspect, a wire harness comprises a bundle of electric wires and the grommet according to any one of the foregoing aspect, the grommet being mounted on the bundle of electric wires.

In the grommet according to each of the foregoing aspects, when the member intended to be protected inside the small-diameter cylindrical portion is pulled, the large-diameter cylindrical portion tends to be deformed inward by the pulling force from the small-diameter cylindrical portion and the connecting portion. In this case, the oblique reduced-diameter portion of the large-diameter cylindrical portion comes into contact with the deformation limiting portion of the small-diameter cylindrical portion, which opposes the oblique reduced-diameter portion. This limits the range of inward deformation of the large-diameter cylindrical portion, thus making it difficult for the grommet to be dislodged from the plate.

Additionally, in the grommet according to each of the foregoing aspects, the deformation limiting portion(s) of the small-diameter cylindrical portion protrudes toward the oblique reduced-diameter portion. This can limit the increase in the weight and cost of the grommet as compared with the case in which the length and thickness of the oblique reduced-diameter portion is increased according to the difference between the diameter of the outer rim of the large-diameter cylindrical portion and that of the inner rim of the small-diameter cylindrical portion (the inner-outer diametric difference).

Furthermore, according to the second aspect, the weight and cost of the grommet can be further reduced as compared with the case in which a deformation limiting portion is continuously formed around the entire periphery of the small-diameter cylindrical portion.

In the third aspect, the small-diameter cylindrical portion has a double structure that includes the inner small-diameter cylindrical portion and the outer small-diameter cylindrical portion. If this double-structured small-diameter cylindrical portion is employed, when the member bound to the small-diameter cylindrical portion in order to mount the grommet to the plate is pushed towards the rear side of the plate, the pushing force is effectively applied from the small-diameter cylindrical portion to the large-diameter cylindrical portion. The deformation limiting portion(s) of the small-diameter cylindrical portion can be applied to such a grommet.

### BRIEF DESCRIPTION OF THE DRAWINGS

FIG. 1 is a side cross-sectional view of a grommet 1 according to a first embodiment.

FIG. 2 is an elevation view of the grommet 1.

FIG. 3 is a partially cutaway side cross-sectional view of a wire harness 10 that includes the grommet 1 mounted to a plate.

FIG. 4 is a partially cutaway side cross-sectional view of the wire harness 10 when a pulling force is applied to the wire harness.

FIG. 5 is a side cross-sectional view of a grommet 1A according to a second embodiment.

FIG. 6 is an elevation view of a grommet 1B according to a third embodiment.

FIG. 7 is a side cross-sectional view of a grommet 1C according to a fourth embodiment.

FIG. 8 is a partially cutaway side cross-sectional view of a wire harness 10C that includes the grommet 1C.

### EMBODIMENTS OF THE INVENTION

Embodiments of the present invention will be described hereinafter with reference to the attached drawings. The embodiments below represent examples of the present invention and do not define the technical scope of the present invention. The grommets in the embodiments described below and the wire harnesses including there same are automotive grommets and wire harnesses to be mounted on vehicles, such as automobiles.

### First Embodiment

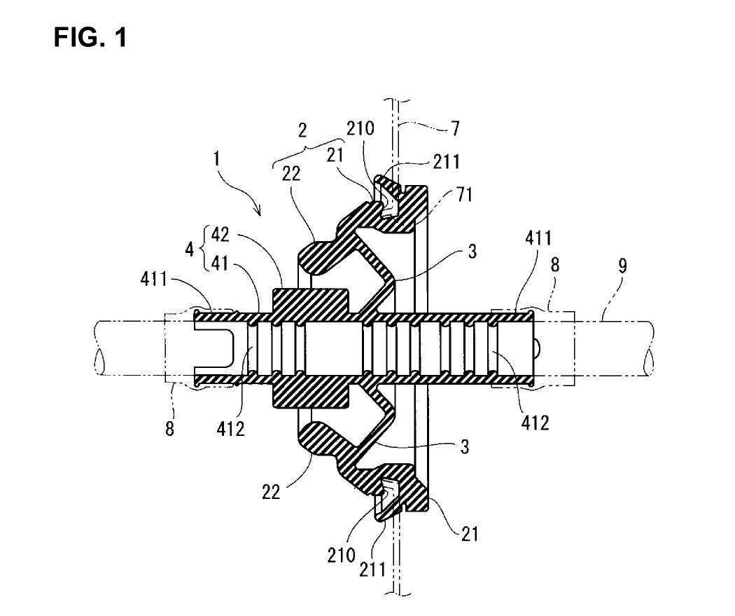

First, a grommet 1 and a wire harness 10 including there same according to a first embodiment will be described with reference to FIGS. 1-4. The grommet 1 fills the gap between a linear member, such as a bundle of wires, and the rim of a hole 71 of a plate 7. In this way, the grommet 1 prevents damage to the linear member due to the linear member coming into contact with the plate 7 and also serves as protection against dust and a waterstop.

The grommet 1 is a member that includes an elastic member predominantly composed of rubber or elastomer, which is a rubber-based material. Examples of elastomers are natural rubber and vulcanized rubber, such as synthetic rubber, as well as thermosetting resin elastomer, such as urethane rubber, silicone rubber, and fluororubber. In this embodiment, the entire grommet 1 is an elastic member.

The grommet 1 (the elastic member) is a member composed of a large-diameter cylindrical portion 2, a connecting portion 3, and a small-diameter cylindrical portion 4. The large-diameter cylindrical portion 2 and the small-diameter cylindrical portion 4 are both cylindrical portions with the large-diameter cylindrical portion 2 having a larger diameter than the small-diameter cylindrical portion 4. The connecting portion 3 is a portion that connects the large-diameter cylindrical portion 2 and the small-diameter cylindrical portion 4. The large-diameter cylindrical portion 2, the connecting portion 3, and the small-diameter cylindrical portion 4 are formed fully circumferentially and continuously.

The large-diameter cylindrical portion 2 has an outer frame portion 21 that includes the outer rim of the grommet 1 and an oblique reduced-diameter portion 22 connected thereto. Formed in the outer frame portion 21 is an annular recess 210 into which the rim of the hole 71 of the plate 7 can be fitted, the plate being where the grommet 1 is to be mounted. The outer frame portion 21 and the oblique reduced-diameter portion 22 are formed fully circumferentially and continuously.

In the large-diameter cylindrical portion 2, the oblique reduced-diameter portion 22 extends obliquely inward from the part of the outer frame portion 21 that is connected to the connecting portion 3. As such, the oblique reduced-diameter portion 22 is formed in the shape of a cone whose diameter gradually decreases from where it is connected to the outer frame portion 21.

The connecting portion 3 is a portion that extends further inward from the inner surface of the large-diameter cylindrical portion 2. The connecting portion 3 is formed thinner than the outer frame portion 21 so as to be susceptible to elastic deformation. When an external force is applied to a member bound to the small-diameter cylindrical portion 4 (a bundle of electric wires 9 to be described below), the connecting portion 3 experiences elastic deformation, thereby displacing the small-diameter cylindrical portion 4 inside the fixed large-diameter cylindrical portion 2. In this embodiment, the connecting portion 3 is formed in the shape of bellows so as to be more susceptible to elastic deformation.

The small-diameter cylindrical portion 4 is a cylindrical portion connected to the connecting portion 3. Formed on each end of the small-diameter cylindrical portion 4 is a bound portion 411 that can be bound to the linear member passed through the interior of the small-diameter cylindrical portion 4.

The small-diameter cylindrical portion 4 includes a cylindrical base portion 41 and a deformation limiting portion 42 that protrudes from the outer peripheral surface of the base portion 41. In this embodiment, the base portion 41 of the small-diameter cylindrical portion 4 is a portion that extends along the outer peripheral surface of the bundle of electric wire 9 (the linear member). The bound portions 411 are formed at the ends of the base portion 41 of the small-diameter cylindrical portion 4.

Moreover, formed on the inner peripheral surface of the base portion 41 are waterstop protrusions 412 that come into intimate contact with the outer peripheral surface of the linear member passed through the base portion 41. The waterstop protrusions 412 are annular protrusions. In the example shown in FIG. 1, a plurality of waterstop protrusions 412 are formed on the inner peripheral surface of the base portion 41 at intervals.

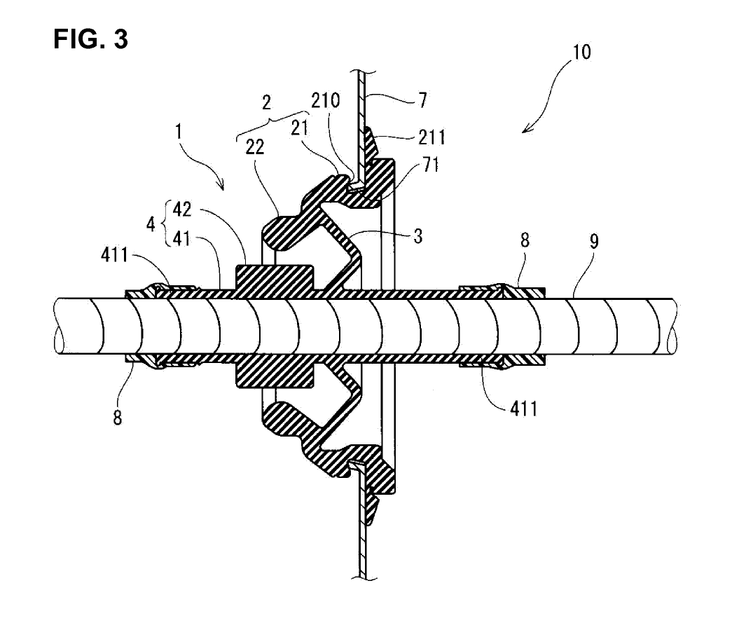

As shown in FIG. 3, the wire harness 10 includes the bundle of electric wires 9, which is an example of the linear member, and the grommet 1, which is penetrated by the bundle of electric wires 9. Furthermore, the wire harness 10 also includes binding material 8 that binds the bundle of electric wires 9 and the bound portions 411 of the small-diameter cylindrical portion 4 of the grommet 1.

The binding material 8 is, for example, adhesive tapes or binding belts. In the example shown in FIG. 3, the binding material 8 is a series of adhesive tapes wrapped around the bound portions 411 and the bundle of electric wires 9.

In FIG. 1, the bundle of electric wires 9, which are an example of the linear material, the binding material 8, and the plate 7 are drawn in phantom lines (chain double-dashed lines). Additionally, FIG. 3 shows a cross-sectional view of the plate 7, the grommet 1 mounted to the plate 7, and the binding material 8, and a side view of the bundle of electric wires 9.

The deformation limiting portion 42 is a portion that protrudes farther than other parts of the outer peripheral surface of the base portion 41 and is formed where it opposes the oblique reduced-diameter portion 22 of the large-diameter cylindrical portion 2. That is, the deformation limiting portion 42 is formed to protrude towards the oblique reduced-diameter portion 22.

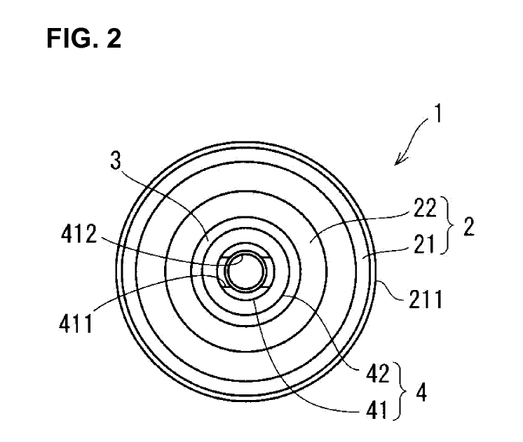

As shown in FIG. 2, in this embodiment, the deformation limiting portion 42 is an annular protrusion formed on the outer peripheral surface of the base portion 41 around its entire periphery. The deformation limiting portion 42 is formed along the length of the base portion 41 between a position longitudinally inside of the large-diameter cylindrical portion 2 and a position longitudinally outside of the large-diameter cylindrical portion 2. Furthermore, in this embodiment, the deformation limiting portion 42 is spaced apart from the connecting portion 3.

The grommet 1 is mounted to the plate 7, which partitions the inside of the vehicle into the interior side and the exterior side. More specifically, the grommet 1 is secured to the plate 7 by fitting together the recess 210 of the outer frame portion 21 and the rim of the hole 71 in the plate 7. The plate 7 also serves as a support plate that supports the grommet 1. Note that in the example shown in FIGS. 1 and 3, flanging has been carried out on the rim of the hole 71 in the plate 7.

In the grommet 1 mounted to the plate 7, the part of the large-diameter cylindrical portion 2 that is on the same side of the recess 210 as the oblique reduced-diameter portion 22 is located on the exterior side of the plate 7, and the opposite part is located on the interior side of the plate 7.

The operator who mounts the grommet 1 to the plate 7 accesses the hole 71 in the plate 7 from the interior side. Accordingly, the exterior side of the plate 7 is the rear side for the operator.

When the grommet 1 is mounted to the plate 7, the part of the grommet 1 on the same side as the oblique reduced-diameter portion 22 is inserted into the hole 71 in the plate 7 from the interior side. As a result of this, the oblique reduced-diameter portion 22 is elastically and inwardly deformed by the pressure received from the rim of the hole 71 in the plate 7. Moreover, the outer frame portion 21 is also elastically and inwardly deformed following the deformation of the oblique reduced-diameter portion 22 until the rim of the hole 71 in the plate 7 fits into the recess 210.

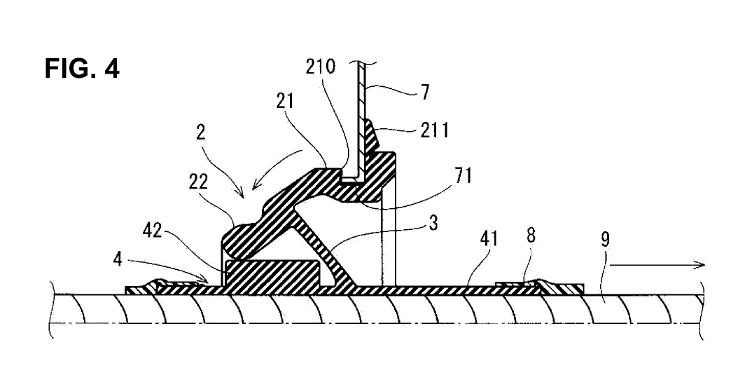

FIG. 4 shows the condition of the wire harness 10 when the bundle of electric wires 9 (the linear member) is pulled along its length towards the interior side of the vehicle.

When the bundle of electric wires 9 is pulled toward the interior side with the grommet 1 mounted to the plate 7, the large-diameter cylindrical portion 2 tends to be deformed inward by the pulling force from the small-diameter cylindrical portion 4 and the connecting portion 3. In this case, the oblique reduced-diameter portion 22 of the large-diameter cylindrical portion 2 comes into contact with the deformation limiting portion 42 of the small-diameter cylindrical portion 4, which opposes the oblique reduced-diameter portion, and is hardly deformed further inward.

In other words, the deformation limiting portion 42 limits the range of inward deformation of the oblique reduced-diameter portion 22. In this way, as the range of inward deformation of the large-diameter cylindrical portion 2 is limited, the grommet 1 is not easily dislodged from the plate 7.

If the oblique reduced-diameter portion 22 of the large-diameter cylindrical portion 2 is formed long in order to narrow the gap between the oblique reduced-diameter portion 22 and the small-diameter cylindrical portion 4, the oblique reduced-diameter portion 22 needs to be thick (i.e., to increase the rigidity) so that the oblique reduced-diameter portion 22 is not bent upon coming into contact with the small-diameter cylindrical portion 4. Moreover, if a portion of the large-diameter cylindrical portion 2, with its large diameter, is formed long and thick, the weight and cost of the grommet tend to increase.

In the grommet 1, the deformation limiting portion 42 of the small-diameter cylindrical portion 4 protrudes toward the oblique reduced-diameter portion 22. This can limit the increase in the weight and cost of the grommet 1 as compared with the case in which the length and thickness of the oblique reduced-diameter portion 22 is increased according to the difference between the diameter of the outer frame portion 21 of the large-diameter cylindrical portion 2 and that of the base portion 41 of the small-diameter cylindrical portion 4 (the inner-outer diametric difference).

### Second Embodiment

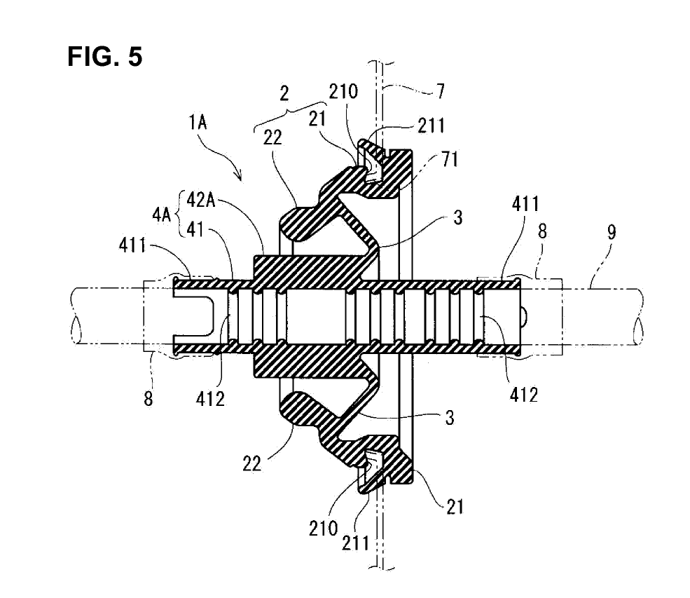

Next, a grommet 1A of a second embodiment that is applicable to a wire harness 10 will be described with reference to FIG. 5. The grommet 1A is different from the grommet 1 shown in FIGS. 1-4 only in the range in which the deformation limiting portion is formed.

FIG. 5 is a side cross-sectional view of the grommet 1A. In FIG. 5, components identical to those shown in FIGS. 1-4 are designated with identical reference numerals. The differences between the grommet 1A and the grommet 1 will be described hereinafter.

The grommet 1A includes a large-diameter cylindrical portion 2, a connecting portion 3, and a small-diameter cylindrical portion 4A. The small-diameter cylindrical portion 4A includes a base portion 41 and a deformation limiting portion 42A.

As shown in FIG. 5, in this embodiment, the deformation limiting portion 42A is connected to the connecting portion 3. It should be noted that, as in the deformation limiting portion 42, the deformation limiting portion 42A is formed along the length of the base portion 41 between a position longitudinally inside of the large-diameter cylindrical portion 2 and a position longitudinally outside of the large-diameter cylindrical portion 2.

Even if the grommet 1A shown in FIG. 5 is used with the wire harness 10 in place of grommet 1, the same effect as using the grommet 1 can be obtained.

### Third Embodiment

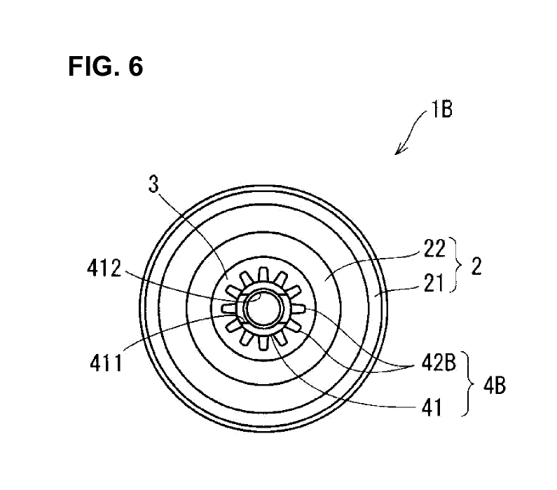

Next, a grommet 1B of a third embodiment that is applicable to a wire harness 10 will be described with reference to FIG. 6. The grommet 1B is different from the grommet 1 shown in FIGS. 1-4 only in the range in which the deformation limiting portions are formed.

FIG. 6 is an elevation view of the grommet 1B. In FIG. 6, components identical to those shown in FIGS. 1-4 are designated with identical reference numerals. The differences between the grommet 1B and the grommet 1 will be described hereinafter.

The grommet 1B includes a large-diameter cylindrical portion 2, a connecting portion 3, and a small-diameter cylindrical portion 4B. The small-diameter cylindrical portion 4B includes a base portion 41 and a deformation limiting portions 42B. The small-diameter cylindrical portion 4B has a plurality of deformation limiting portions 42B formed side by side at intervals around the periphery of the base portion 41.

In the example shown in FIG. 6, twelve deformation limiting portions 42B are formed at regular intervals around the periphery of the base portion 41. However, the number of deformation limiting portions 42B is not so limited. Moreover, it is also contemplated to form the parts between the plurality of deformation limiting portions 42B thicker than other parts of the base portion 41.

If the grommet 1B shown in FIG. 6 is used with the wire harness 10 in place of grommet 1, the same effect as using the grommet 1 can be obtained. Furthermore, if the grommet 1B is used, its weight and cost can be further reduced as compared with the case where a deformation limiting portions is continuously formed around the entire periphery of the base portion 41.

In the grommet 1B, the deformation limiting portions 42B of the small-diameter cylindrical portion 4 are the portions that are pressed toward their bases from their tops by the oblique reduced-diameter portion 22 upon coming into contact with the oblique reduced-diameter portion 22. Accordingly, as shown in FIG. 6, although formed with a relatively narrow width, the deformation limiting portions 42 are not susceptible to buckling under the pressure from the oblique reduced-diameter portion 22.

### Fourth Embodiment

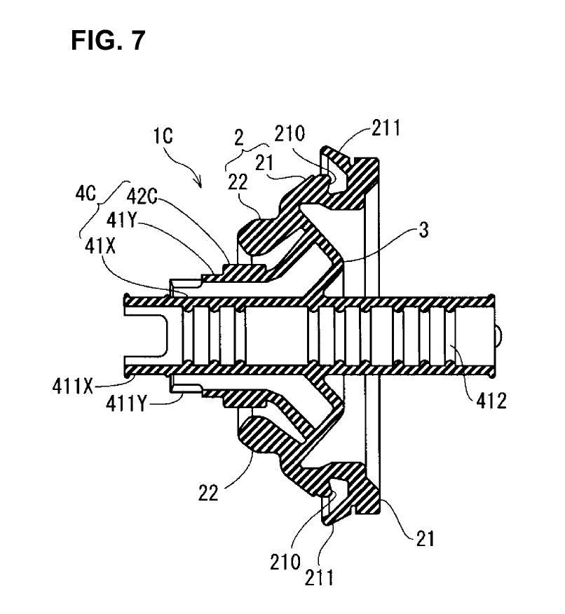

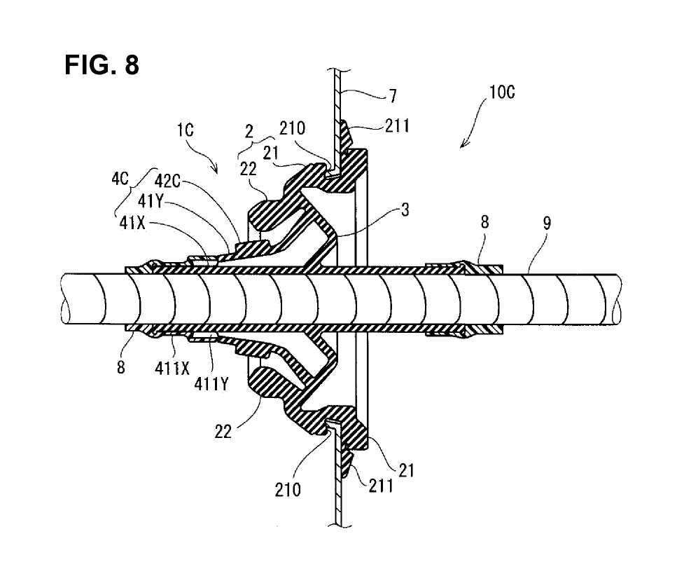

Next, a grommet 1C and a wire harness 10C including there same according to a fourth embodiment will be described with reference to FIGS. 7 and 8. The grommet 1C is different from the grommet 1 shown in FIGS. 1-4 in that the small-diameter cylindrical portion has a double structure.

FIG. 7 is a side cross-sectional view of the grommet 1C. FIG. 8 is a partially cutaway side cross-sectional view of the wire harness 10C. More particularly, FIG. 8 shows a cross-sectional view of the plate 7, the grommet 1C mounted to the plate 7, and the binding material 8, and a side view of a bundle of electric wires 9. In FIGS. 7 and 8, components identical to those shown in FIGS. 1-4 are designated with identical reference numerals. The following describes how the grommet 1C and the wire harness 10C differ from the grommet 1 and the wire harness 10.

The grommet 1C includes a large-diameter cylindrical portion 2, a connecting portion 3, and a small-diameter cylindrical portion 4C. The small-diameter cylindrical portion 4C includes an inner small-diameter cylindrical portion 41X, an outer small-diameter cylindrical portion 41Y, and a deformation limiting portion 42C.

In the small-diameter cylindrical portion 4C of the grommet 1C, the inner small-diameter cylindrical portion 41X is the cylindrical portion connected to the innermost part of the connecting portion 3. The outer small-diameter cylindrical portion 41Y is the portion connected to a part of the connecting portion 3 closer to the large-diameter cylindrical portion 2 than the part of the connecting portion 3 connected to the inner small-diameter cylindrical portion 41X.

Accordingly, the outer small-diameter cylindrical portion 41Y is formed outside of the inner small-diameter cylindrical portion 41X. In the other words, the small-diameter cylindrical portion 4C has a double structure that includes the inner small-diameter cylindrical portion 41X and the outer small-diameter cylindrical portion 41Y.

Formed on each end of the inner small-diameter cylindrical portion 41X is a bound portion 411X that can be bound to the bundle of electric wires 9 passed through the interior of the small-diameter cylindrical portion 4C. Similarly formed on one end of the outer small-diameter cylindrical portion 41Y is a bound portion 411Y that can be bound to the bundle of electric wires 9 passed through the interior of the small-diameter cylindrical portion 4C.

As shown in FIG. 8, the bundle of electric wires 8, which is one example of the linear member, is bound by the binding material 8 to both of the bound portions 411X of the inner small-diameter cylindrical portion 41X and the bound portion 411Y of the outer small-diameter cylindrical portion 41Y.

The deformation limiting portion 42C is formed on the outer small-diameter cylindrical portion 41Y. More particularly, the deformation limiting portion 42C is a portion that protrudes farther than other parts of the outer peripheral surface of the outer small-diameter cylindrical portion 41Y and is formed where it opposes the oblique reduced-diameter portion 22 of the large-diameter cylindrical portion 2. That is, the deformation limiting portion 42C is formed to protrude towards the oblique reduced-diameter portion 22.

The deformation limiting portion 42C is formed along the length of the outer small-diameter cylindrical portion 41Y between a position longitudinally inside of the large-diameter cylindrical portion 2 and a position longitudinally outside of the large-diameter cylindrical portion 2

As in the case of the deformation limiting portion 42 of FIG. 2, it may be contemplated to form the deformation limiting portion 42C continuously around the periphery of the outer small-diameter cylindrical portion 41Y. Alternatively, as in the case of the deformation limiting portion 42B of FIG. 6, it may also be contemplated to form a plurality of deformation limiting portions 42C side by side at intervals around the periphery of the outer small-diameter cylindrical portion 41Y.

If the double-structured small-diameter cylindrical portion 4C is employed, when the bundle of electric wires 9 bound to the small-diameter cylindrical portion 4C to mount the grommet 1C to the plate 7 is pushed towards the rear side of the plate 7, the pushing force is effectively applied from the small-diameter cylindrical portion 4C to the large-diameter cylindrical portion 2.

As the pushing force is effectively applied from the small-diameter cylindrical portion 4C to the large-diameter cylindrical portion 2, the grommet 1C can be mounted to the plate 7 with a relatively small force. The deformation limiting portion(s) may be applied to such a grommet 1C.

### Variants

It may be contemplated to provide the grommets 1, 1A, 1B, and 1C with a structure that combines an elastic member predominantly composed of rubber or elastomer and a resin member or a metal member. For example, it may be contemplated to provide the grommets 1, 1A, 1B, and 1C with a structure in which a reinforcing resin or metal member is set in an elastic member and a portion thereof.

Furthermore, it may also be contemplated that the linear members protected by the grommets 1, 1A, 1B, and 1C include a member other than electric wires, such as an optical fiber cable or a hose for carrying a fluid.

It should be noted that the grommets and the wire harnesses according to the present invention may be constructed by freely combining the foregoing embodiments and variants or by modifying, or omitting part of, the foregoing embodiments and variants as appropriate within the scope of the invention set forth in the claims.

### LIST OF REFERENCE NUMERALS

1, 1A, 1B, 1C Grommets

10, 10C Wire harnesses

2 Large-diameter cylindrical portion

21 Outer frame portion

210 Recess

22 Oblique reduced-diameter portion

3 Connecting portion

4, 4A, 4B, 4C Small-diameter cylindrical portions

41 Base portion

411, 411X, 411Y Bound portions

412 Waterstop protrusions

41X Inner small-diameter cylindrical portion

41Y Outer small-diameter cylindrical portion

42, 42A, 42B, 42C Deformation limiting portions

7 Plate

71 Hole

8 Binding material

9 Bundle of electric wires

What is claimed is:

1. A grommet having an elastic member comprising:
a large-diameter cylindrical portion having an annular recess formed therein into which a rim of a hole in a plate can be fitted,
a connecting portion extending fully circumferentially and further inward from an inner surface of the large-diameter cylindrical portion, and
a small-diameter cylindrical portion connected to the connecting portion and capable of being bound at its ends to a member that penetrates an interior of the small-diameter cylindrical portion,
wherein the large-diameter cylindrical portion includes an oblique reduced-diameter portion extending fully circumferentially and obliquely inward from where the large-diameter cylindrical portion is connected to the connecting portion, and
wherein the small-diameter cylindrical portion includes a deformation limiting portion that protrudes farther than other parts of the small-diameter cylindrical portion to oppose the oblique reduced-diameter portion such that the deformation limiting portion limits the range of inward deformation of the oblique reduced-diameter portion.

2. The grommet according to claim 1, wherein a plurality of the deformation limiting portions are formed side by side at intervals around the periphery of the small-diameter cylindrical portion.

3. The grommet according to claim 1, wherein the small-diameter cylindrical portion comprises:
an inner small-diameter cylindrical portion connected to an innermost part of the connecting portion, and
an outer small-diameter cylindrical portion formed outside of the inner small-diameter cylindrical portion so as to be connected to a part of the connecting portion closer to the large-diameter cylindrical portion than the part of the connecting portion connected to the inner small-diameter cylindrical portion, wherein the deformation limiting portion is formed on the outer small-diameter cylindrical portion.

4. The grommet according to claim 2, wherein the small-diameter cylindrical portion comprises:
an inner small-diameter cylindrical portion connected to an innermost part of the connecting portion, and
an outer small-diameter cylindrical portion formed outside of the inner small-diameter cylindrical portion so as to be connected to a part of the connecting portion closer to the large-diameter cylindrical portion than the part of the connecting portion connected to the inner small-diameter cylindrical portion, wherein the deformation limiting portions are formed on the outer small-diameter cylindrical portion.

5. A wire harness comprising a bundle of electric wires and a grommet mounted on the bundle of electric wires, the grommet having an elastic member comprising:
a large-diameter cylindrical portion having an annular recess formed therein into which a rim of a hole in a plate can be fitted,
a connecting portion extending fully circumferentially and further inward from an inner surface of the large-diameter cylindrical portion, and
a small-diameter cylindrical portion connected to the connecting portion and capable of being bound at its ends to the bundle of electric wires penetrating an interior of the small-diameter cylindrical portion,
wherein the large-diameter cylindrical portion includes an oblique reduced-diameter portion extending fully circumferentially and obliquely inward from where the large-diameter cylindrical portion is connected to the connecting portion, and
wherein the small-diameter cylindrical portion includes a deformation limiting portion that protrudes farther than other parts of the small-diameter cylindrical portion to oppose the oblique reduced-diameter portion such that the deformation limiting portion limits the range of inward deformation of the oblique reduced-diameter portion.
